(19) United States
(12) Patent Application Publication
(10) Pub. No.: US 2017/0168832 A1
(43) Pub. Date: Jun. 15, 2017

(54) INSTRUCTION WEIGHTING FOR PERFORMANCE PROFILING IN A GROUP DISPATCH PROCESSOR

(71) Applicant: International Business Machines Corporation, Armonk, NY (US)

(72) Inventors: ALEXANDER E. MERICAS, AUSTIN, TX (US); MARIA L. PESANTEZ, AUSTIN, TX (US); MYSORE S. SRINIVAS, AUSTIN, TX (US)

(21) Appl. No.: 14/966,561

(22) Filed: Dec. 11, 2015

(51) Int. Cl. G06F 9/38; G06F 9/30

(52) U.S. Cl. CPC G06F 9/3851; G06F 9/30145

(57) ABSTRACT

Methods, apparatuses, and computer program products for instruction weighting for performance profiling in a group dispatch processor are described. In a particular embodiment, a post processing profiler retrieves an execution sample including an instruction address of a youngest instruction in a dispatch group that has completed execution in a group dispatch processor and a number of instructions in the dispatch group. In the particular embodiment, the post processing profiler identifies, based on the instruction address of the youngest instruction and the number of instructions in the dispatch group, all of the instructions that are in the dispatch group at the time that the dispatch group completes execution. In the particular embodiment, the post processing profiler applies within an execution profile, the result of the execution sample, equally to all of the identified instructions that are in the dispatch group.

### BACKGROUND OF THE INVENTION

Field of the Invention

The field of the invention is data processing, or, more specifically, methods, apparatuses, and computer program products for instruction weighting for performance profiling in a group dispatch processor.

Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

In order to improve the performance of a software program, the execution of the program may be analyzed to measure and identify where in the software program a processor is executing. To locate the frequently executed part of a program, execution profiling tools may utilize hardware performance event counters built into the processor to track the occurrence of a particular event or time lapse. At the occurrence of the particular event or time lapse, a monitoring unit may collect a sample of machine data within the processor. For example, the collected sample may count the Instruction Pointer (IP) addresses encountered during the sampling. Execution profiling tools may analyze the collected sample to attribute portions of the sample to each IP address based on the number of times the IP address appears in the sample. Generally, IP addresses that are attributed the highest percentage of a sample are the likeliest of being a ‘hotspot’ or problem area within the program.

### SUMMARY OF THE INVENTION

Methods, apparatuses, and computer program products for instruction weighting for performance profiling in a group dispatch processor are described. In a particular embodiment, a post processing profiler retrieves an execution sample including an instruction address of a youngest instruction in a dispatch group that has completed execution in a group dispatch processor and a number of instructions in the dispatch group. In the particular embodiment, the post processing profiler identifies, based on the instruction address of the youngest instruction and the number of instructions in the dispatch group, all of the instructions that are in the dispatch group at the time that the dispatch group completes execution. In the particular embodiment, the post processing profiler applies within an execution profile, the result of the execution sample, equally to all of the identified instructions that are in the dispatch group.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of an example system configured for instruction weighting for performance profiling in a group dispatch processor.

FIG. 2 sets forth a flow chart illustrating an example method of instruction weighting for performance profiling in a group dispatch processor.

FIG. 3 sets forth a flow chart illustrating another example method of instruction weighting for performance profiling in a group dispatch processor.

FIG. 4 sets forth a flow chart illustrating another example method of instruction weighting for performance profiling in a group dispatch processor.

FIG. 5 sets forth a diagram of an example user interface of a post processing profiler for instruction weighting for performance profiling in a group dispatch processor.

### DETAILED DESCRIPTION OF EXEMPLARY EMBODIMENTS

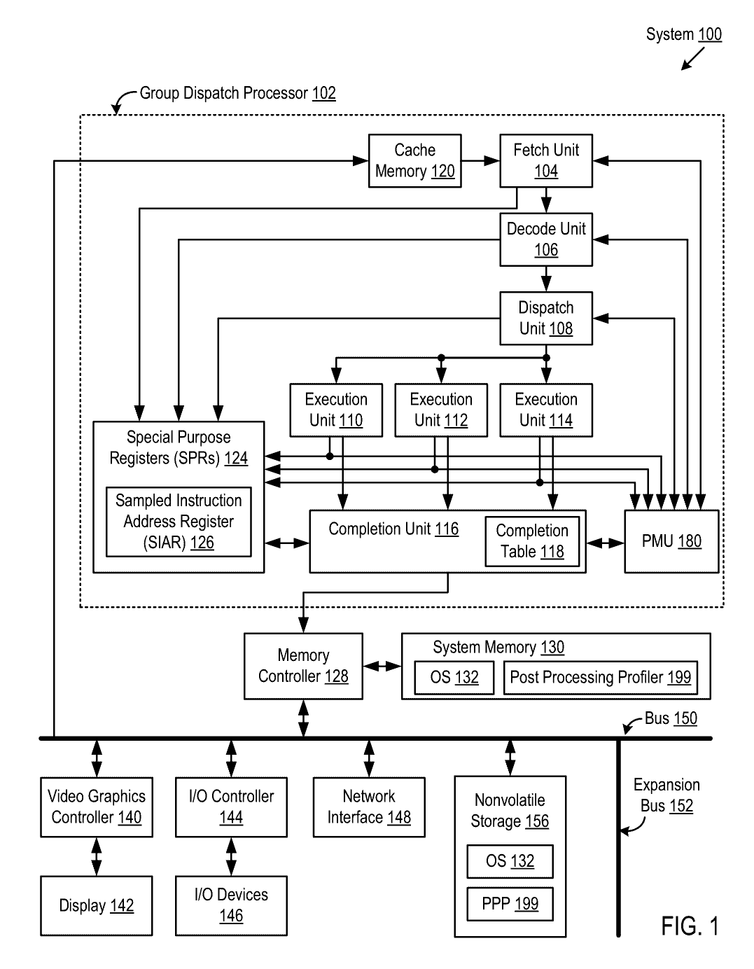

Exemplary methods, apparatuses, and computer program products for instruction weighting for performance profiling in a group dispatch processor in accordance with the present invention are described with reference to the accompanying drawings, beginning with FIG. 1.

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

With reference now to the figures, FIG. 1 sets forth a diagram of an example system (100) configured for instruction weighting for performance profiling in a group dispatch processor (102). The system (100) may take the form of a desktop, server, portable, laptop, notebook, or other form factor computer or data processing system. The system (100) may also take other form factors such as a gaming device, a personal digital assistant (PDA), a portable telephone device, a communication device or other devices that include a processor and memory. The primary task of the system (100) is the processing of software programs by execution of instructions as single instructions or instruction groups.

A group dispatch processor dispatches and completes instructions according to a group. In the illustrative embodiment, the group dispatch processor (102) is a superscalar microprocessor, including units, registers, buffers, memories, and other sections, shown and not shown, all of which are formed by integrated circuitry. It will be apparent to one skilled in the art that additional or alternate units, registers, buffers, memories and other sections may be implemented within the group dispatch processor (102) for full operation. In one example, the group dispatch processor (102) operates according to reduced instruction set computer (RISC) techniques.

In the example of FIG. 1, the system (100) includes the group dispatch processor (102), a memory controller (128), and system memory (130). The group dispatch processor (102) of FIG. 1 includes a cache memory (120), a fetch unit (104), a decode unit (106), a dispatch unit (108), a plurality of execution units (110, 112, 114), and a completion unit (116).

In one embodiment, the group dispatch processor (102) represents a pipeline system with supporting hardware and software. Instructions advance through the processor (102) from stage to stage. For example, the fetch unit (104), the decode unit (106), and the dispatch unit (108) may represent the first three stages of a pipeline. Instructions move from the cache memory (120) to the first stage or the fetch unit (104) and so on through each successive stage. The execution units (110, 112, 114) represent the next stage of the pipeline system after the dispatch unit (108). The completion unit (116) represents the final stage of the pipeline in this example. The next instruction advancing through the final stage or the completion unit (116) is the next to complete instruction.

The system memory (130) is coupled to the cache memory (120) via a bus (150) and the memory controller (128). The system memory (130) acts as a source of instructions that the processor (102) executes. The cache memory (120) provides a local copy of portions of the system memory (130) for use by the group dispatch processor (102) during operation. The cache memory (120) may include a separate instruction cache (I-cache) and a data cache (D-cache). Alternatively, the cache memory (120) may store instructions along with data in a unified cache structure. The cache memory (120) may also contain instruction or thread data or other memory data.

The cache memory (120) is coupled to the fetch unit (104) to provide the group dispatch processor (102) with instruction information for instruction processing. The fetch unit (104) may fetch instructions from one or more levels of the memory cache (120). The fetch unit (104) provides fetched instructions to the decode unit (106), which decodes the fetched instructions and provides the decoded instructions to the dispatch unit (108). The type and level of decoding performed by the decode unit (106) may depend on the type of architecture implemented. In one example, the decode unit (106) decodes complex instructions into a group of instructions. It will be apparent to one skilled in the art that additional or alternate components may be implemented within the processor (102) for holding, fetching and decoding instructions.

In the example of FIG. 1, the dispatch unit (108) receives decoded instructions or groups of decoded instructions from the decode unit (106) and dispatches the instructions in groups, in order of their programmed sequence, to the execution units (110, 112, 114). In the example, the dispatch unit (108) may receive a group of instructions tagged for processing as a group from the decode unit (106). In another example, the dispatch unit (108) may combine sequential instructions into an instruction group of a capped number of instructions. In one example, instruction groups may include one or more instructions dependent upon the results of one or more other instructions in the instruction group. In another example, instruction groups may include instructions that are not dependent upon the results of any other instruction in the group.

In a particular embodiment, when the dispatch unit (108) dispatches an instruction group to the execution units (110, 112, 114), the dispatch unit (108) assigns a group tag (GTAG) to the instruction group and assigns or associates individual tags (ITAGs) to each individual instruction within the dispatched instruction group. In one example, individual tags are assigned in sequential order based on the program order of the instruction group.

The dispatch unit (108) may dispatch the instruction group tags to the completion unit (116) for entry in a completion table (118). In a particular embodiment, the completion unit (116) manages entries in the completion table (118) to track the finish status of each individual instruction within an instruction group and to track the completion status of each instruction group. The finish status of an individual instruction within a next to complete instruction group may be used to trigger a performance monitoring unit (180) to store a stall reason and stall count in association with the instruction. The completion status of an instruction group in the completion table (118) may be used for multiple purposes, including initiating the transfer of the results of the completed instructions to general purpose registers and triggering the performance monitoring unit (180) to store the stall reasons and stall counters tracked for each instruction in the instruction group. In a particular embodiment, the completion table (118) may be used as a reorder buffer to keep track of instruction execution or program order.

In the example of FIG. 1, each of the execution units (110, 112, 114) is capable of processing an instruction and returning the results to registers. In actual practice, other embodiments of the processor may employ fewer or more execution units than representative group dispatch processor (102). Each execution unit (110, 112, 114) couples to the completion unit (116) to provide the group dispatch processor (102) with instruction completion data. The completion unit (116) couples to the system memory (130) via the memory controller (128) to provide completion data, such as instruction completion information, for storage in the system memory (130).

The fetch unit (104), the decode unit (106), the dispatch unit (108), the execution units (110, 112, 114), and the completion unit (116) are coupled to a bank or group of special purpose registers (SPRs) (124) that store register information regarding the processing of instructions within the group dispatch processor (102). Although the SPRs (124) store specific register information for purposes of this example, other processor special purpose registers may store a wide variety of unique register assignments for group dispatch processor operations. In the example that FIG. 1 depicts, SPRs (124) include a sampled instruction address register (SIAR) (126).

In a particular embodiment, the SPRs (124) are directly accessible by software executing in the system memory (130), such as an operating system (OS) (132) and a post processing profiler (199). In other embodiments, the SPRs (124) may include scratch or temporary registers for use by the group dispatch processor (102) as temporary storage registers. The SPRs (124) may be any type of accessible read and write memory in the group dispatch processor (102). The SPRs (124) act as a local memory store within the group dispatch processor (102).

As explained above, the group dispatch processor (102) treats instructions as a group. The processor (102) may be configured to store, within the SIAR (126), the last instruction or instruction group to complete within the processor (102). As an instruction completes, the address of the completed instruction loads into the STAR (126). Instructions may execute within the group dispatch processor out of program order. In a particular embodiment, the SPRs may be configured to store information in addition to the instruction address of the SIAR (126), such as completion stall clock cycle data, and stall condition data. Stall condition data may represent stall conditions within the group dispatch processor (102) that may be the cause of the stall, delay, or blockage of the last instruction.

The PMU (180) may be configured to control the capture of the data within the STAR (126). A PMU is a software-accessible mechanism capable of providing detailed information descriptive of the utilization of instruction execution resources and storage control. In the example of FIG. 1, the PMU (180) is coupled to each functional unit of the processor (102) in order to permit the monitoring of all aspects of the operation of the processor (102), including, for example, reconstructing the relationship between events, identifying false triggering, identifying performance bottlenecks, monitoring pipeline stalls, monitoring idle cycles, determining dispatch efficiency, determining branch efficiency, determining the performance penalty of misaligned data accesses, identifying the frequency of execution of serialization instructions, identifying inhibited interrupts, and determining performance efficiency. In a particular embodiment, the PMU (180) may contain one or more performance monitor counters (PMCs) that accumulate the occurrence of internal events that impact the performance of a processor. For example, a PMU may monitor processor cycles, instructions completed, or delay cycles that execute a load from memory. These statistics are useful in optimizing the architecture of a processor and the instructions that the processor executes.

Typically a timer or PMU interrupt is used to trigger when an execution sample is taken. An execution sample may include an instruction execution address at the time of the interrupt as well as other useful information that can be used to further analyze the execution (such as a call-back trace to identify how the particular instruction address was reached).

In a particular embodiment, the PMU may be configured to interrupt the processor (102) after a pre-determined number of instructions have been executed or a predetermined number of processor clock cycles have passed. As part of the PMU interrupt processing, the processor (102) captures the address instruction of the youngest instruction in the dispatch group in the STAR, which is the last instruction in the group. The processor (102) may also be configured to determine the number of instructions in the dispatch group. Both the number of instructions in the dispatch group and the instruction address of the youngest address in the dispatch group may be stored by the processor (102) in the system memory.

For example, the instruction address of the youngest instruction in the dispatch group may be captured by the group dispatch processor in response to an interrupt, such as a PMU interrupt. In a particular embodiment, the interrupt may be triggered by the group dispatch processor in response to one of: a first predetermined number of instructions completing execution and a second predetermined number of clock cycles completing.

Also included in the system memory (130) is a post processing profiler (199). A post processing profiler may be configured to collect and analyze data from a processor to measure and identify where in a software program a processor is executing. The post processing profiler (199) may be configured to use the instruction address of the youngest instruction and the number of instructions in the dispatch group to identify all of the instructions that are in the dispatch group at the time that the dispatch group completes execution. The post processing profiler (199) may also be configured to apply, within an execution profile, the result of the execution sample, equally to all of the identified instructions that are in the dispatch group.

In one example, the post processing profiler (199) collects data from the SPRs (124) on a periodic basis. By capturing continuous data from the SPRs (124), a collection of execution sample data accrues in system memory (130). System users or other resources can interrogate the accrual of machine data in system memory (130) to generate a representative analysis of instruction execution frequency, specific instructions that suffer a completion stall delay, and conditions of the system (100) that cause the instruction completion stalls or delays. The accumulation and analysis of instructions by machine data presents opportunities for performance improvement within the system (100).

The disclosed embodiment identifies not only the youngest instruction in the dispatch group but all of the instructions in the dispatch group. By identifying all of the instructions in a dispatch group of an execution sample, the post processing software (199) can apply within the execution profile, the result of the execution sample equally to all of the identified instructions that are in the dispatch group. Weighting all of the instructions in the dispatch group allows a determination of the types and frequencies of performance bottlenecks to be may be made with great specificity. For example, by repeatedly sampling a test program, specific “hot spot” addresses that are associated with particular pipeline blockages can be identified. Because the specific causes of the pipeline blockages at these addresses can be easily identified by one or more (and probably multiple) reason fields within the pipeline flow table, a software engineer or hardware designer may determine what modifications to the code and/or processor hardware can be made to optimize data processing system performance.

In addition, the system of FIG. 1 also includes an I/O controller (144) that couples I/O devices (146), such as a keyboard and a mouse pointing device, to the bus (150). I/O controllers implement user-oriented input/output through, for example, software drivers and computer hardware for controlling output to display devices such as computer display screens, as well as user input from user input devices such as keyboards and mice. The system (100) of FIG. 1 also includes a video graphics controller (140), which is an example of an I/O controller specially designed for graphic output to a display device (142) such as a display screen or computer monitor.

A network adapter or a network interface (148) couples to the bus (150) to enable the system (100) to carry out data communications by connecting by wire or wirelessly to a network and other information handling systems. Such data communications may be carried out serially through RS-232 connections, through external buses such as a Universal Serial Bus (‘USB’), through data communications networks such as IP data communications networks, and in other ways as will occur to those of skill in the art. Network adapters implement the hardware level of data communications through which one computer sends data communications to another computer, directly or through a data communications network. Examples of network adapters useful in computers configured for instruction weighting for performance profiling in a group dispatch processor according to embodiments of the present invention include modems for wired dial-up communications, Ethernet (IEEE 802.3) adapters for wired data communications, and 802.11 adapters for wireless data communications.

The system (100) also includes a nonvolatile storage (156), such as a hard disk drive, CD drive, DVD drive, or other nonvolatile storage couples to the bus (182) to provide the system (100) with permanent storage of information. One or more expansion busses (152), such as USB, IEEE 1394 bus, ATA, SATA, PCI, PCIE and other busses, couple to the bus (150) to facilitate the connection of peripherals and devices to the system (100).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

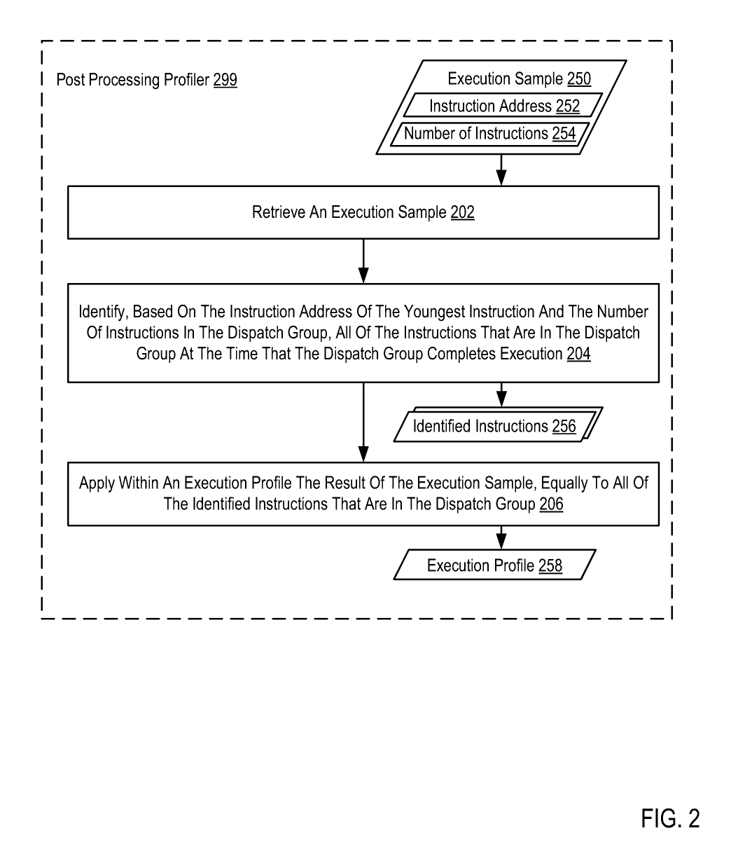

For further explanation, FIG. 2 sets forth a flow chart illustrating an example method of instruction weighting for performance profiling in a group dispatch processor. The method of FIG. 2 includes a post processing profiler (299) retrieving (202) an execution sample (250). An execution sample is a collection of data indicating the number of times that a particular instruction address is captured during a triggering of an event. In the example of FIG. 2, the execution sample (250) includes an instruction address (252) of a youngest instruction in a dispatch group that has completed execution in a group dispatch processor. The execution sample (250) of FIG. 2 also includes a number (254) of instructions in the dispatch group. Retrieving (202) an execution sample (250) may be carried out by examining the contents of system memory to identify data representing the execution sample. Alternatively, the post processing software (299) may retrieve the execution sample by polling one or more registers within the processor (102) of FIG. 1, such as the SIAR (126) or a register within the PMU (180).

The method of FIG. 2 also includes the post processing profiler (299) identifying (204), based on the instruction address (252) of the youngest instruction and the number (254) of instructions in the dispatch group, all of the instructions (256) that are in the dispatch group at the time that the dispatch group completes execution. In a particular embodiment, the number of instructions in the dispatch group is determined by the group dispatch processor. In a particular embodiment, the number of instructions in the dispatch group is the number of instructions in the dispatch group at the time that the dispatch group completes execution. Identifying (204), based on the instruction address (252) of the youngest instruction and the number (254) of instructions in the dispatch group, all of the instructions (256) that are in the dispatch group at the time that the dispatch group completes execution may be carried out by examining a completion table to identify the last number of instructions executed by the processor where the last number is the number (254) of instructions in the dispatch group.

The method of FIG. 2 also includes the post processing profiler (299) applying (206) within an execution profile (258), the result of the execution sample (250), equally to all of the identified instructions (256) that are in the dispatch group. An execution profile is a listing of data that attributes percentages of execution samples to portions of a program. In a particular embodiment, the execution profile may directly attribute a percentage of an execution profile to a particular instruction or function within a program. Applying (206) within an execution profile (258), the result of the execution sample (250), equally to all of the identified instructions (256) that are in the dispatch group may be carried out by calculating the percentage of the sample attributed to the instructions in the dispatch group and storing a value associated with the execution profile to indicate that percentage to each instruction in the identified instructions of the dispatch group.

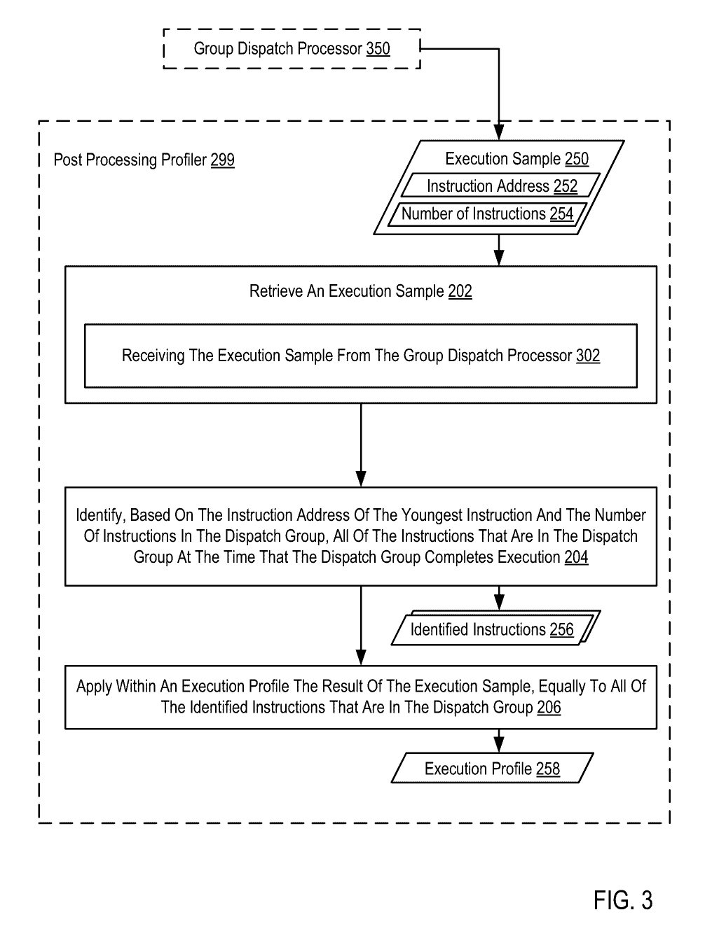

For further explanation, FIG. 3 sets forth a flow chart illustrating another example method of instruction weighting for performance profiling in a group dispatch processor. The method FIG. 3 is similar to the method of FIG. 2 in that the method of FIG. 3 also includes retrieving (202) an execution sample (250); identifying (204), based on the instruction address (252) of the youngest instruction and the number (254) of instructions in the dispatch group, all of the instructions (256) that are in the dispatch group at the time that the dispatch group completes execution; and applying (206) within an execution profile (258), the result of the execution sample (250), equally to all of the identified instructions (256) that are in the dispatch group.

In the method of FIG. 3, however, retrieving (202) an execution sample (250) includes receiving (302) the execution sample (250) from the group dispatch processor (350). Receiving (302) the execution sample (250) from the group dispatch processor (350) may be carried out by the group dispatch processor storing the execution sample in system memory, where the post processing profiler may access the execution sample. Alternatively, receiving (302) the execution sample may be carried out the post processing profiler polling one or more registers within the group dispatch processor, such as the STAR (126) of FIG. 1. In a particular embodiment, receiving (302) the execution sample may include receiving the execution sample directly from one or more units of the group dispatch processor, such as the performance monitoring unit (PMU) (180) of FIG. 1.

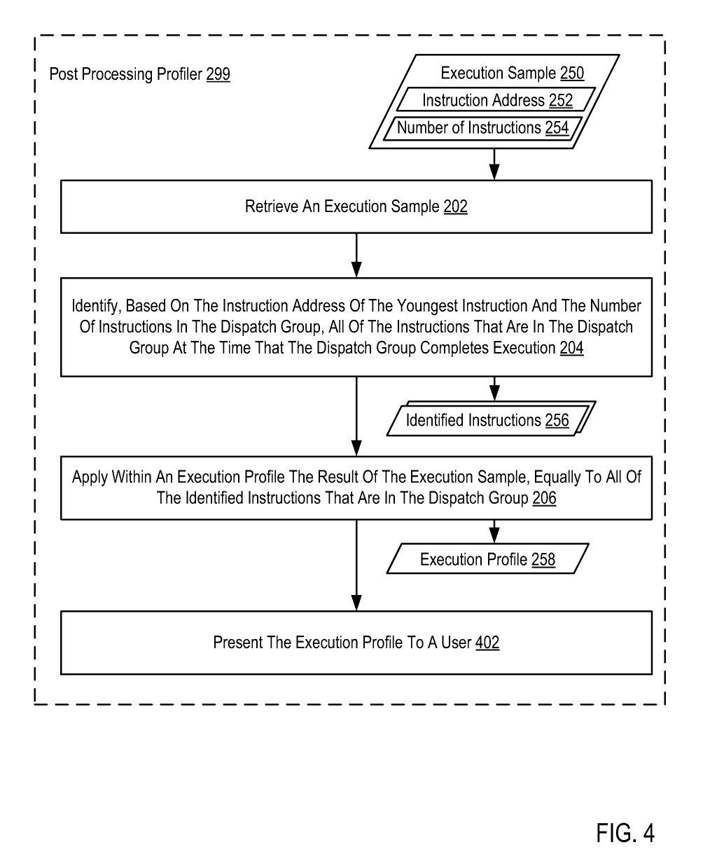

For further explanation, FIG. 4 sets forth a flow chart illustrating another example method of instruction weighting for performance profiling in a group dispatch processor. The method FIG. 4 is similar to the method of FIG. 2 in that the method of FIG. 4 also includes retrieving (202) an execution sample (250); identifying (204), based on the instruction address (252) of the youngest instruction and the number (254) of instructions in the dispatch group, all of the instructions (256) that are in the dispatch group at the time that the dispatch group completes execution; and applying (206) within an execution profile (258), the result of the execution sample (250), equally to all of the identified instructions (256) that are in the dispatch group.

The method of FIG. 4, however, also includes presenting (402) the execution profile (258) to a user. Presenting (402) the execution profile (258) to a user may be carried out by generating one or more windows or graphical user interfaces that includes data associated with the execution profile; and instructing one or more components of a system to display the windows or graphical user interfaces to a user, such as on a display screen of a computer monitor.

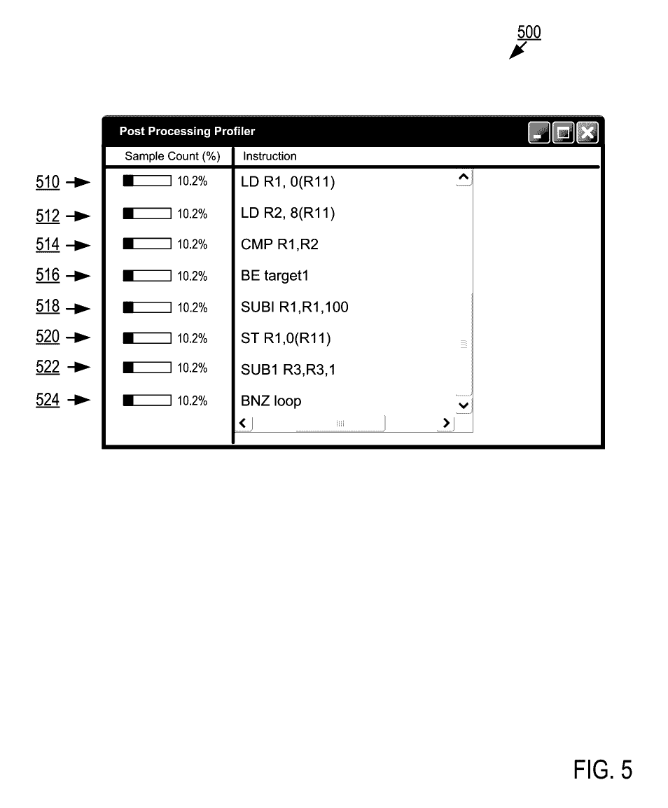

For further explanation, FIG. 5 sets forth a diagram of an example user interface (500) of a post processing profiler for instruction weighting for performance profiling in a group dispatch processor. In the example of FIG. 5, the user interface (500) is a window that is generated to present an execution profile to a user.

The example user interface (500) of FIG. 5 presents an execution profile that includes a listing of instructions of a computer program and a listing of a sample count. The sample count may be a visual indication of the percentage of an execution sample that is attributed to a particular instruction. In the example of FIG. 5, the execution profile has eight lines (510-524), where each line includes an instruction and a visual representation of the sample count that is attributed to that instruction.

As explained above, a post processing profiler may be configured to identify all of the instructions that are in a dispatch group at the time that the dispatch group completes execution; and apply within an execution profile the result of the execution sample equally to all of the identified instructions that are in the dispatch group.

For example, the post processing profiler may determine that the instructions listed in the first line (510), the second line (512), the third line (514), the fourth line (516), the fifth line (518), the sixth line (520), the seventh line (522), and the eighth line (524) where all part of the same dispatch group and therefore the post processing profiler applied within the execution profile the result of the execution sample equally to all of the identified instructions of that dispatch group. Continuing with this example, all of the lines (510-524) each have the same percentage of the sample count attributed to their corresponding instructions. Readers of skill in the art will realize that FIG. 5 is just one possible embodiment of a presentation of an execution profile and that applying an execution to portions of a software program may be visually represented in any number of ways including but not limited to colors, histograms, pie charts, and percentage summaries.

Weighting all of the instructions in the dispatch group allows a determination of the types and frequencies of performance bottlenecks to be may be made with great specificity. For example, by repeatedly sampling a test program, specific “hot spot” addresses that are associated with particular pipeline blockages can be identified. Because the specific causes of the pipeline blockages at these addresses can be easily identified by one or more (and probably multiple) reason fields within the pipeline flow table, a software engineer or hardware designer may determine what modifications to the code and/or processor hardware can be made to optimize data processing system performance.

Exemplary embodiments of the present invention are described largely in the context of a fully functional computer system for instruction weighting for performance profiling in a group dispatch processor. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1-7. (canceled)

8. An apparatus for instruction weighting for performance profiling in a group dispatch processor, the apparatus comprising a computer processor and a computer memory operatively coupled to the computer processor, the computer memory having disposed within it computer program instructions that, when executed by the computer processor, cause the apparatus to carry out the steps of:
retrieving, by a post processing profiler, an execution sample, wherein the execution sample includes:
an instruction address of a youngest instruction in a dispatch group that has completed execution in a group dispatch processor; and
a number of instructions in the dispatch group; and
based on the instruction address of the youngest instruction and the number of instructions in the dispatch group, identifying, by the post processing profiler, all of the instructions that are in the dispatch group at the time that the dispatch group completes execution; and
applying within an execution profile, by the post processing profiler, the result of the execution sample, equally to all of the identified instructions that are in the dispatch group.

9. The apparatus of claim 8 wherein the number of instructions in the dispatch group is determined by the group dispatch processor.

10. The apparatus of claim 8 wherein the instruction address of the youngest instruction in the dispatch group is captured by the group dispatch processor in response to an interrupt.

11. The apparatus of claim 10 wherein the interrupt is triggered by the group dispatch processor in response to one of: a first predetermined number of instructions completing execution and a second predetermined number of clock cycles completing.

12. The apparatus of claim 8, wherein retrieving the execution sample includes receiving the execution sample from the group dispatch processor.

13. The apparatus of claim 8 wherein the number of instructions in the dispatch group is the number of instructions in the dispatch group at the time that the dispatch group completes execution.

14. The apparatus of claim 8 wherein the computer memory includes computer program instructions that, when executed by the computer processor, cause the apparatus to carry out the steps of presenting the execution profile to a user.

15. A computer program product for instruction weighting for performance profiling in a group dispatch processor, the computer program product comprising a computer readable storage medium having program instructions embodied therewith, the program instructions executable by a computer to cause the computer to:
retrieve, by a post processing profiler, an execution sample, wherein the execution sample includes:
an instruction address of a youngest instruction in a dispatch group that has completed execution in a group dispatch processor; and
a number of instructions in the dispatch group; and
based on the instruction address of the youngest instruction and the number of instructions in the dispatch group, identify, by the post processing profiler, all of the instructions that are in the dispatch group at the time that the dispatch group completes execution; and
apply within an execution profile, by the post processing profiler, the result of the execution sample, equally to all of the identified instructions that are in the dispatch group.

16. The computer program product of claim 15 wherein the number of instructions in the dispatch group is determined by the group dispatch processor.

17. The computer program product of claim 15 wherein the instruction address of the youngest instruction in the dispatch group is captured by the group dispatch processor in response to an interrupt.

18. The computer program product of claim 17 wherein the interrupt is triggered by the group dispatch processor in response to one of: a first predetermined number of instructions completing execution and a second predetermined number of clock cycles completing.

19. The computer program product of claim 15, wherein retrieving the execution sample includes receiving the execution sample from the group dispatch processor.

20. The computer program product of claim 15 wherein the number of instructions in the dispatch group is the number of instructions in the dispatch group at the time that the dispatch group completes execution.
